(19) United States
(12) Patent Application Publication
(10) Pub. No.: US 2006/0103768 A1
(43) Pub. Date: May 18, 2006

(54) Front filter of display panel and fabrication method thereof

(76) Inventors: Young-Joo Yee, Seongnam (KR); Hyouk Kwon, Seoul (KR); Chang-Hoon Oh, Seoul (KR); Tae-Sun Lim, Suwon (KR)

Correspondence Address: MCKENNA LONG & ALDRIDGE LLP;Song K. Jung, 1900 K Street, N.W., Washington, DC, 20006, US

(21) Appl. No.: 11/268,502

(22) Filed: Nov. 8, 2005

(30) Foreign Application Priority Data
Nov. 9, 2004 (KR) 10-2004-0091064

(51) Int. Cl. G02F 1/1335

(52) U.S. Cl. 349/5

(57) ABSTRACT

Disclosed is a front filter of a display panel and its fabrication method capable of improving optical performance by using an image display microlens array sheet. A front filter of a display panel for performing shielding of an electro-magnetic wave emitted from the display panel and optical compensation, includes a microlens array sheet reducing light diffusion by refracting light emitted from the display panel.

This application claims priority to Korean Application 10-2004-0091064 filed on Nov. 9, 2004, which is incorporated by reference, as if fully set forth herein.

### BACKGROUND OF THE INVENTION

1. Field of the Invention

The present invention relates to a front filter of an image display device and its fabrication method, and particularly, to a front filter of a display panel and its fabrication method capable of improving optical performance by using a microlens array sheet.

2. Description of the Background Art

Recently, various display devices having the high image quality and a large area are being provided in response to demands for a high-quality flat panel display device with a large screen. Particularly, a plasma display panel using a plasma technology is being developed greatly. As for the plasma display panel, light emitted from each cell of the panel undergoes optical compensation and electromagnetic wave shielding by using a filter and then is viewed by a viewer. Because of characteristics of the plasma display panel, distinctive vision contrast is determined through a black matrix and a filter placed between cells of the panel by light scattered randomly, and contrast improvement is being required due to a black matrix rate, namely, a limitation of a BM rate. Also, regarding to characteristics of light, directions of light need to be concentrated on the front side to improve the front brightness.

FIG. 1 is a view that illustrates a front filter of a plasma display panel 204 related to the present invention.

As shown in FIG. 1, the front filter includes an anti reflection film (AR) 201, an electromagnetic interference (EMI) shielding film 202, and a near infra red film (NIR) 203, and performs electromagnetic wave and ultraviolet light shielding, contrast improvement and color compensation while minimizing brightness degradation and moir phenomenon.

FIG. 2 is a detailed construction view of the electromagnetic interference (EMI) shielding film 202 included in the front filter of the plasma display panel shown in FIG. 1. The electromagnetic interference (EMI) shielding film 202 includes a conductive mesh using copper or the like, a conductive film (202-1) or a PET film (202-2), and the layer is adhered by an adhesive agent (202-3).

The front filter of the plasma display panel shields an electromagnetic wave or ultraviolet rays emitted from the plasma display panel 204 and performs improvement of contrast and color compensation while not affecting an image. To shield the electromagnetic wave, a conductive film and a conductive mesh (202-1) are used, the front filter is fabricated in consideration of the electromagnetic wave shielding effect, transmittance and the moir prevention.

The plasma display device more requires improvement of distinctive vision contrast and front brightness as the length and the number of electrodes of the panel are increased in response to demands for high precision and a larger size. However, the related art front filter is problematic in improving the distinctive vision contrast and front brightness.

### BRIEF DESCRIPTION OF THE INVENTION

Therefore, an object of the present invention is to provide a front filter of a display panel and its fabrication method capable of improving optical characteristics by adding a microlens array sheet to a front filter.

To achieve these and other advantages and in accordance with the purpose of the present invention, as embodied and broadly described herein, there is provided a front filter of a display panel for performing shielding of an electro-magnetic wave emitted from the display panel and optical compensation, the front filter comprising: a microlens array sheet reducing light diffusion by refracting light emitted from the display panel.

To achieve these and other advantages and in accordance with the purpose of the present invention, as embodied and broadly described herein, there is provided a method for fabricating a front filter of a display panel, comprising: fabricating a microlens array sheet by arranging microlenses on one surface of a predetermined substrate at regular intervals; and inserting the microlens array sheet to a predetermined position of the front filter.

Preferably, the display panel includes a plasma display panel, and the microlens array sheet includes a predetermined substrate and a microlens array formed at the front surface of the substrate.

Preferably, the substrate is formed of a polymer material.

Preferably, an individual lens of the microlens array is formed as a plane convex lens.

Preferably, a sectional shape of the individual lens of the microlens array is a spherical, aspheric or anamorphic shape.

Preferably, the microlens array sheet further includes a black matrix formed at a rear surface of the substrate.

Preferably, the black matrix is formed at an entire surface excluding a light aperture.

Preferably, the black matrix is fabricated integrally with a conductive mesh that shields an electromagnetic wave within the front filter.

Preferably, the microlens array sheet is fabricated by combining a plurality of lens sheets, and the plurality of lens sheets are different kinds of lens sheets.

Preferably, the plurality of lens sheets include a diffraction lens sheet.

Preferably, the microlens array sheet is inserted in an electromagnetic interference shielding film among a near infra red film, an electromagnetic interference shielding film and an anti reflection film.

Preferably, the microlens array sheet includes a black matrix and the black matrix is disposed at a lower end of a conductive mesh layer constituting the electromagnetic interference film.

Preferably, the microlens array sheet includes a black matrix, and the black matrix is fabricated integrally with a conductive mesh constituting the electromagnetic shielding film.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a unit of this specification, illustrate embodiments of the invention and together with the description serve to explain the principles of the invention.

In the drawings:

FIG. 1 is a view that illustrates a structure of a front filter of a plasma display panel related to the present invention;

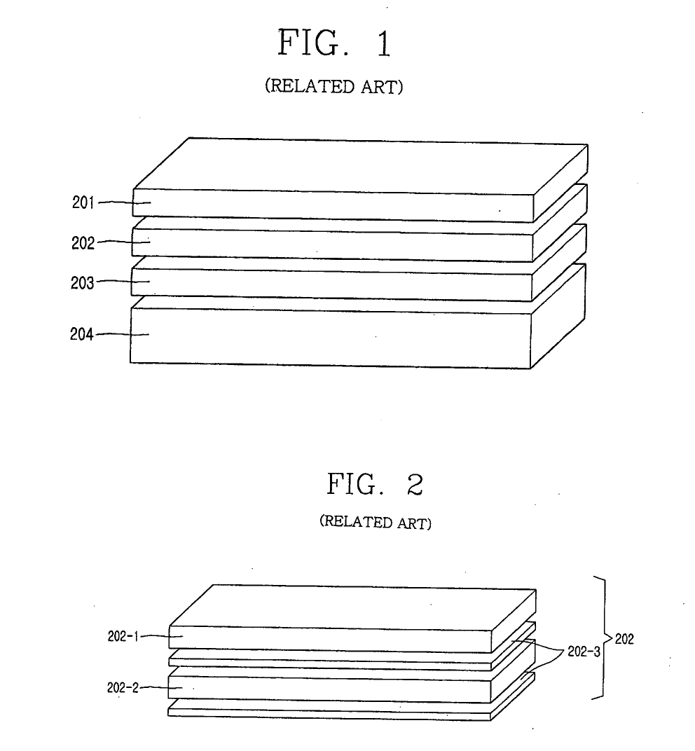

FIG. 2 is a view that illustrates an electromagnetic wave shielding film of a front filter of the plasma display panel illustrated in FIG. 1 in detail;

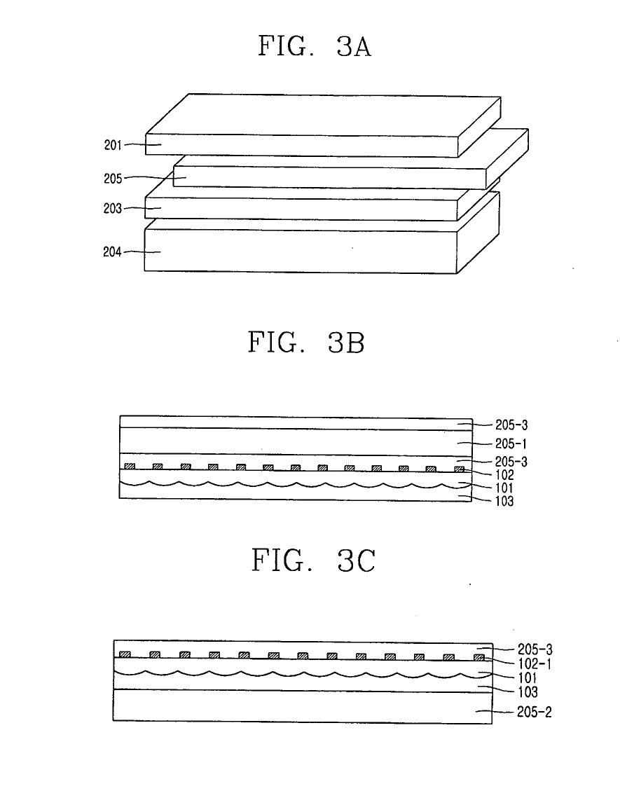

FIGS. 3A to 3C are views that illustrate a structure of a front filter of a plasma display panel using a microlens array sheet in accordance with one embodiment of the present invention;

FIGS. 4A, 4B and 4C are views that illustrate a structure of the front filter of the plasma display panel using the microlens array sheet in accordance with other embodiments of the present invention; and

FIGS. 5A and 5B are a perspective view, a plan view, a bottom view and sectional view of the microlens array sheet used for the present invention.

### DETAILED DESCRIPTION OF THE INVENTION

Reference will now be made in detail to the preferred embodiments of the present invention, examples of which are illustrated in the accompanying drawings. The same reference numerals are designated to the same elements, and the known function and structure that may obscure the gist of the present invention will be omitted.

In the present invention, a display panel to which a front filter is applied is limited to a plasma display panel for the purpose of simplicity in description, but the present invention is not limited thereto.

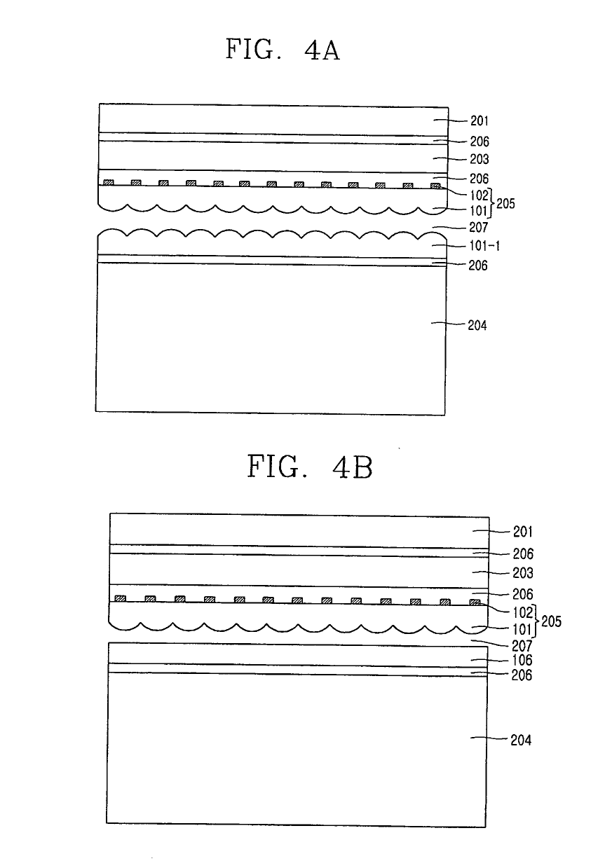

FIGS. 3A to 3C are sectional views that illustrate a front filter of the plasma display panel in accordance with one embodiment of the present invention.

As shown in FIG. 3A, the front filter of the plasma display panel in accordance with one embodiment of the present invention includes an anti reflection (AR) film 201, a near infra red (NIR) film 203 and an electro-magnetic interference (EMI) shielding film 205 including the microlens array sheet.

In the embodiment, the microlens array sheet is laminated on the electro-magnetic film 205 but may be laminated at another place within the front filter.

Preferably, a conductive mesh or a conductive film using copper is used as the electro-magnetic interference shielding film 205.

FIG. 3B is a view that illustrates the microlens array sheet applied to the electromagnetic interference shielding film in accordance with one embodiment of the present invention in detail. A microlens array sheet 101 and a conductive mesh 205-1 are sequentially laminated on the electromagnetic interference shielding film 205, and the microlens array sheet 101 and the conductive mesh 205-1 are adhered to each other by an adhesive agent 205-3. Adhesive agents 103 and 205-3 are formed at a surface where the microlens is formed in the microlens array sheet 101 and on the conductive mesh 205-1, so that the near infra red film 203 and the anti reflection film 201 are attached thereto, respectively.

The microlens array sheet 101 concentrates diffused light of light emitted from the plasma display panel, and fight is transmitted through a light aperture of a black matrix 102 formed at the opposite side of the microlens array sheet 101.

In order to concentrate diffused light, a combination of lenses which include two or more unit lenses or microlens array sheets may be used, and a combination of Fresnel's lens may be used when necessary. Also, control for a proper refractive index is required. A distinctive vision contrast can be improved by increasing a black matrix rate of the microlens array sheet. Also, by properly reducing diffusion of light, the front brightness can be improved. The control of the diffusion of light can be made corresponding to objective optical performance by controlling values of the front brightness and a viewing angle which are in a trading-off relation.

The lens 101 of the microlens array sheet may be aligned with a unit cell of a panel and mounted at the plasma display panel, or may have a considerably smaller size than a cell size and mounted with no regard to the alignment.

FIG. 3C is a view that illustrates a structure that a microlens array sheet is applied to an electro-magnetic interference shielding film in accordance with a different embodiment of the present invention, and in the drawing, a black matrix 102-1 formed at the microlens array sheet 101 and a conductive mesh 205-3 are integrally formed.

Referring to FIG. 3C, the microlens array sheet 101 is laminated on a PET film 205-2, the black matrix 102-1 is formed on the microlens array sheet 101, and then, the conductive mesh 205-3 is laminated thereon. Preferably, the PET film 205-2 and the microlens array sheet 101 are adhered by an adhesive agent 103. The black matrix 102-1 formed on the microlens array sheet 101 is formed integrally with the conductive mesh 205-3.

In the related art, although shielding an electromagnetic wave, the conductive mesh has disadvantages of lowering an entire transmittance because it uses a metallic mesh. However, in the present invention, a conductive black matrix is used by making the black matrix integral to the conductive mesh 205-3, or a black matrix layer is inserted in a lower end layer of the metallic mesh layer. Accordingly, the transmittance can be improved, and electro-magnetic wave shielding can be efficiently improved.

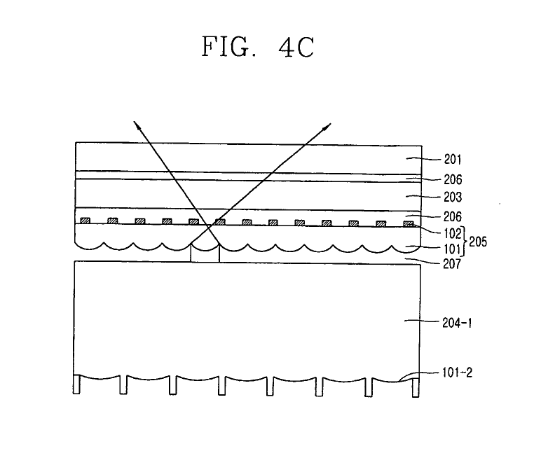

FIG. 4A illustrates a different embodiment of the present invention. As shown in FIG. 4A, microlens array sheets 101-1 and 101 formed by a combination of two or more lenses are used, so that light coming out from a PDP panel is formed similar to parallel light and thusly is properly concentrated. At the portion excluding a light aperture, the contrast and the front brightness can be improved by a structure that the black matrix and the conductive mesh are integrally formed.

FIG. 4B is a different embodiment of the present invention. In the embodiment, a diffraction lens sheet 106 such as a Fresnel's lens is used instead of the microlens array sheet 101-1 of FIG. 4A, so as to make the light similar to the parallel light. Through the microlens array sheet 101, optical performance of the PDP is improved.

FIG. 4C is another different embodiment of the present invention. In the embodiment, a diffraction lens 101-2 formed at a front glass 204-1 of a plasma display panel is used instead of the microlens array sheet 101-1 of FIG. 4A.

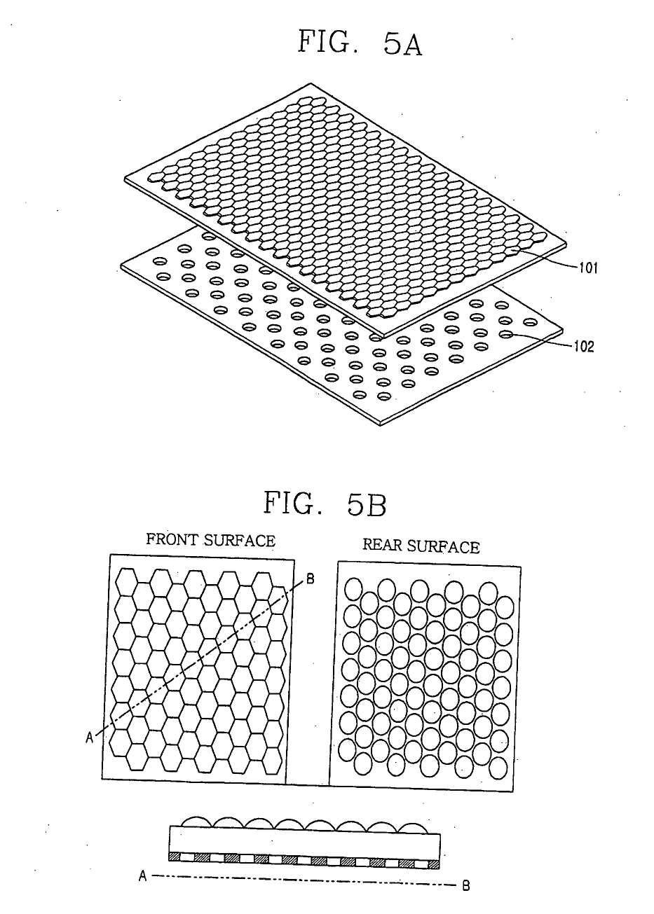

FIG. 5A is a perspective view of a microlens array sheet in accordance with one embodiment of the present invention, and FIG. 5B is a plan view and a bottom view and sectional view of the microlens array sheet in accordance with one embodiment of the present invention.

As shown in FIGS. 5A and 5B, the microlens array sheet 101 includes a sheet or a film type substrate formed to mount a microlens thereon, a microlens array formed on an entire surface of a substrate, and a black matrix 102 formed at the opposite side. A hexagonal shape of the microlens is taken as an example, but the microlens may have a quadrangular shape or a diamond shape. The lens constituting the microlens array sheet 101 is preferably formed as a plane convex lens, the vertical and horizontal curvatures of the lens shape may be different, and the shape may be an anamorphic shape including an aspheric surface. An interval between microlenses is almost zero, namely, a filling ratio reaches almost 100%, so that light efficiency can be maximized. The size of a lens constituting the unit microlens array sheet 101 is proper when it is within a range of tens of micrometers to hundreds of micrometers. Preferably, the substrate is made of a polymer material working as a supporter required in lens formation, and the material forming the microlens array sheet has a high transmittance. Also, a light aperture aligned corresponding to each microlens is formed at the opposite side of the microlens surface, and the entire surface excluding the light aperture is effectively formed of a black matrix. A black matrix rate (BM rate) is a value capable of controlling the distinctive vision contrast, and, generally, when the BM rate is increased, the distinctive vision contrast is increased. The material of the black matrix may be black photosensitive ink, black nano particle, or the like.

According to the present invention, the microlens array sheet is added to the front filter of the display panel, so that the distinctive vision contrast is improved, and the front brightness is also improved.

Also, because the microlens array sheet is integrated in a conductive mesh performing the electromagnetic wave shielding function within the front filter, the optical performance and the electromagnetic wave shielding function can be improved more efficiently.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifictaions that fall within the metes and bounds of the claims, or equivalence of such metes and bounds are therefore intended to be embraced by the appended claims.

What is claimed is:

1. A front filter of a display panel for performing shielding of an electromagnetic wave emitted from the display panel and optical compensation, the front filter comprising:
a microlens array sheet reducing light diffusion by refracting light emitted from the display panel.

2. The front filter of claim 1, wherein the display panel includes a plasma display panel.

3. The front filter of claim 1, wherein the microlens array sheet includes a predetermined substrate and a microlens array formed at the front surface of the substrate.

4. The front filter of claim 3, wherein the substrate is formed of a polymer material.

5. The front filter of claim 3, wherein an individual lens of the microlens array is formed as a plane convex lens.

6. The front filter of claim 3, wherein a sectional shape of the individual lens of the microlens array is a spherical, aspheric or anamorphic shape.

7. The front filter of claim 3, wherein the microlens array sheet further includes a black matrix formed at a rear surface of the substrate.

8. The front filter of claim 7, wherein the black matrix is formed at an entire surface excluding a light aperture.

9. The front filter of claim 7, wherein the black matrix is fabricated integrally with a conductive mesh that shields an electromagnetic wave within the front filter.

10. The front filter of claim 1, wherein the microlens array sheet is fabricated by combining a plurality of lens sheets.

11. The front filter of claim 10, wherein the plurality of lens sheets are different kinds of lens sheets.

12. The front filter of claim 10, wherein the plurality of lens sheets include a diffraction lens sheet.

13. The front filter of claim 1, wherein the microlens array sheet is inserted in an electromagnetic interference shielding film among a near infra red film, an electromagnetic interference shielding film and an anti reflection film.

14. The front filter of claim 13, wherein the microlens array sheet includes a black matrix and the black matrix is disposed at a lower end of a conductive mesh layer constituting the electromagnetic interference film.

15. The front filter of claim 13, wherein the microlens array sheet includes a black matrix, and the black matrix is fabricated integrally with a conductive mesh constituting the electromagnetic shielding film.

16. A method for fabricating a front filter of a display panel, comprising:
fabricating a microlens array sheet by arranging microlenses on one surface of a predetermined substrate at regular intervals; and
inserting the microlens array sheet to a predetermined position of the front filter.

17. The method of claim 16, wherein the step of fabricating the microlens array sheet further comprises forming a black matrix on the other surface of the substrate.

18. The method of claim 17, wherein the black matrix is formed on an entire surface excluding a light aperture.

19. The method of claim 17, wherein the black matrix is inserted in an electromagnetic interference shielding film among a near infra red film, an electro-magnetic interference shielding film and an anti reflection film.

20. The method of claim 17, wherein the black matrix is fabricated integrally with a conductive mesh performing the electromagnetic interference shielding function.
